(19) United States
(12) Patent Application Publication
(10) Pub. No.: US 2005/0185650 A1
(43) Pub. Date: Aug. 25, 2005

(54) Method for improved handling of dynamic bandwidth changes in a transport network using inverse multiplexing

(75) Inventors: Alf Neustadt, Stuttgart (DE); Pascal Treillard, Palaiseau (FR); Yutaka Isonuma, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 11/013,445

(22) Filed: Dec. 17, 2004

(30) Foreign Application Priority Data
Dec. 19, 2003 (EP) 03293249.3

(51) Int. Cl. H04L 12/28

(52) U.S. Cl. 370/395.1

(57) ABSTRACT

One of the objects of the invention is a method for improved handling of dynamic bandwidth changes in a transport network using inverse multiplexing such that at least one connection end-point of a connection does not correspond to an inverse multiplexing end-point, a method including a step wherein said at least one connection end-point is informed of said bandwidth change by at least one inverse multiplexing end-point aware of said bandwidth change.

This application is based on and claims the benefit of European Patent Application No. 03293249.3 filed Dec. 19, 2003, which is incorporated by reference herein.

### BACKGROUND OF THE INVENTION

The present invention is generally concerned with communication systems.

The present invention in particular applies to mobile communication systems, in particular third generation mobile communication systems, such as in particular UMTS (<< Universal Mobile Telecommunication System >>).

In a general way, mobile communication systems are subject to standardisation; therefore, for more information on such systems, it is possible to refer to the corresponding standards, published by the corresponding standardisation bodies.

It is simply recalled that the general architecture of a mobile communication system essentially comprises, as illustrated in FIG. 1:
a Radio Access Network 1, or RAN,
a Core Network 4, or CN.

The RAN comprises network elements such as base stations 2 and base station controllers 3. The RAN is in relation, on the one hand with mobile terminals 5, via an interface 6, and on the other hand with the CN via an interface 7. The CN is in relation with external networks (not illustrated specifically). Within the RAN, the base stations communicate with the base station controllers via an interface 8.

In systems of UMTS type, the RAN is called UTRAN (UMTS Terrestrial Radio Access Network), the base stations are called Node B, the base station controllers are called RNC (Radio Network Controller), and the mobile terminals are called UE (User Equipment). The interface 6 is called Uu interface, the interface 7 is called lu interface, the interface 8 is called lub interface, and an interface 9 between RNCs, called lur interface, is also introduced. The interface 6 is also called radio interface, and the interfaces 7, 8, 9, are also called terrestrial interfaces. The network elements of UTRAN are connected via a transport network (not illustrated specifically). A logical link within this transport network enables two network elements to communicate via one of the terrestrial interfaces lub, lur, lu.

One of the transport technologies used in UTRAN is ATM (Asynchronous Transfer Mode), based on an asynchronous time multiplexing of packets of fixed length called cells. In a general way, ATM is subject to standardisation; therefore, for more information, it is possible to refer to the corresponding standards, published by the corresponding standardisation bodies. It is simply recalled that the protocol layers in an ATM network include, besides a physical layer, an ATM layer and an ATM Adaptation Layer (AAL). The ATM layer is connection oriented, and performs cell transmission on a logical connection between a source and a destination, this logical connection also being called Virtual Channel (VC). Besides, several VCs can be regrouped to form a Virtual Path (VP). The source and destination are also called ATM Virtual Path Connection (VPC) end-points, and the nodes of the transport network between ATM VPC end-points are also called ATM VP cross-connects.

IMA (Inverse Multiplexing for ATM) is a technique defined by ATM Forum, allowing to carry an ATM connection (a VPC) over more than one physical link, thus allowing a VP bandwidth to overcome the limit of the physical link rate on which it is carried (see AF-PHY-0086.001: Inverse Multiplexing for ATM (IMA) Specification Version 1.1). Briefly recalled, the process in inverse multiplexing for ATM is the reverse of multiplexing. IMA performs a distribution of ATM cells over a group of physical links, also called IMA group or IMA bundle. The ATM layer remains transparent to the functions performed by IMA, which belong to the physical layer.

IMA is for instance potentially useful on E1 interfaces, offering 2.048 Mbit/s bit rate, out of which 1.920 Mbit/s can be used with usual ATM mapping (see ITU-T recommendation G.804: ATM cell mapping into Plesiochronous Digital Hierarchy (PDH)). Without IMA, a VP is thus limited to at most 1.920 Mbit/s for its Peak Cell Rate, whereas it can go up to almost twice more if two E1 interfaces are used with IMA.

IMA also gives more flexibility, allowing to offer bandwidth on demand, depending on the needs.

IMA also allows to offer in-built redundancy: if an IMA bundle is made of << n >> physical links, and a failure affects one (or several) of these links, the ATM connection carried on it may still use the << p >> links that remain operational. However, there is of course an impact on the available bandwidth, which is roughly the previous bandwidth multiplied by << p >> and divided by << n >>.

It is relatively easy to know the available bandwidth at the points where the IMA is terminated, but not standardised, as the above-recalled reference (AF-PHY-0086.001) states that “Treatment of CAC (Connection Admission Control) under dynamic bandwidth changes is left to the discretion of the ATM interface implementers”. However, since this is not standardised at the IMA termination point, nothing is defined to inform the endpoint of the ATM connection, if the ATM connection is not terminated at the same place as the IMA. An example where the ATM connection is not terminated at the same place as the IMA is illustrated for instance in FIG. 2.

In a similar way, PPP Multilink protocol (MP) is defined in RFC 1990, which states in its general overview section “the goal of multilink operation is to coordinate multiple independent links between a fixed pair of systems, providing a virtual link with greater bandwidth than any of the constituent members [ . . . ]. All packets received over links identified as belonging to the multilink arrangement are presented to the same network-layer protocol preocessing machine, whether they have multilink headers or not.” RFC 2686 defines the multi-class extension to multi-link PPP, and aims at providing improvements for transmitting high priority packets over multi-link PPP. PPP Multilink protocol presents the same drawbacks as IMA, when the endpoint of the connection, does not correspond to the endpoints of PPP multilink protocol.

In the example illustrated in FIG. 2, a connection established between two connection end-points uses inverse multiplexing for ATM such that a first connection end-point corresponds to an inverse multiplexing for ATM end-point and a second connection end-point does not correspond to an inverse multiplexing for ATM end-point. In this example, the first connection end-point is the one shown on the left side of the figure, the second connection end-point is the one shown on the right side of the figure, and an ATM VP Cross-Connection is shown in the middle of the figure. In this example, a VP is carried between the ATM VPC end-point of the left side and the ATM VP Cross-Connection using IMA (the IMA group in this example is using two E1 links). In this example, a VP is carried between the ATM VP Cross-Connection and the ATM VPC end-point of the right side using a STM-1 (Synchronous Transport Module 1) of the SDH (Synchronous Digital Hierarchy).

In the example illustrated in FIG. 2, nothing is defined to inform the ATM VPC end-point shown on the right side of the figure of a failure of a physical link in the IMA bundle shown on the left side of the figure.

Therefore, one problem to solve is to find a way to detect the failure of link(s) in IMA bundle by an ATM VPC end-point not supporting IMA. This problem in particular arises in the case of the lub interface defined in UMTS, connecting a Node B (assumed here to support IMA), and a Radio Network Controller (RNC) (assumed here not to support IMA), with the use of an intermediate ATM VP cross-connect, terminating the IMA. Indeed, certain actions required to relieve from overload or congestion due to link(s) failure, such as load adjustment to correct this situation, are advantageously implemented in the RNC.

It should be noted that FIG. 2 only illustrates one example where such a problem arises. Such a problem could also arise in other examples, for instance in the case where IMA would not be terminated in an ATM connection end-point, but in an intermediary (not illustrated) node.

A first solution to this problem is to rely on existing ATM maintenance flows, in particular Performance Monitoring (PM) flows (F4 for the example provided above of a VP Connection, or F5 for the supervision of the VCs supported on this VP). This allows detecting ATM cell losses if they occur.

A second solution to this problem is to rely on O&M (Operation and Maintenance) mechanisms: the failure of a physical link can be detected and reported to an Operation and Maintenance Centre, where corrective actions can be taken.

The implementation of the first solution (F4 and/or F5 PM flows) is complex and consumes a significant part of resources. It is not always available in ATM equipment. In addition, it does not provide a clear information on the reason of the ATM cell losses. It also does not provide reliable information, in case the traffic at the time of the failure is low enough to allow it to go through the remaining operational links. At the very moment of the failure, the ATM cells already queued to be transmitted on a physical link will be lost, but as soon as the failure is detected at the IMA termination, the traffic will not be routed via this (or these) links any longer. If the physical capacity remaining operational is big enough compared to the current ATM traffic, no more losses will be detected by F4/F5.

The implementation of the second solution provides means to detect the failure. However, they cannot be assumed to be reliable (the O&M chain does not have the same reliability requirements as the telecom part), and they are likely to provide information too slowly compared to the real time requirements of a telecom application.

Another problem to solve is to optimize the handling of congestion situations due to IMA link(s) failure, in a way that IMA link(s) failure has as little impact as possible on the traffic.

### SUMMARY OF THE INVENTION

The present invention in particular enables to solve part or all of the above-mentioned problems, or to avoid part or all of the above-mentioned drawbacks. More generally the aim of the present invention is to improve the handling of link(s) failure (or more generally dynamic bandwidth changes) in connection with the use of inverse multiplexing (such as in particular IMA) in a transport network (such as in particular the Radio Access Network of a mobile communication system).

It should be noted that IMA is only an example of inverse multiplexing technique to which the present invention applies and for which the present invention will, by way of example, be more particularly disclosed, but that the present invention also applies to other inverse multiplexing techniques such as for example, in the case where the transport technology used on the transport network is IP (Internet Protocol), multilink/multiclass PPP (Point-to-Point Protocol) as defined in particular in RFC 2686 and RFC 1990.

These and other objects are achieved, in one aspect of the present invention, by a method for improved handling of dynamic bandwidth changes in a transport network using inverse multiplexing such that at least one connection end-point of a connection does not correspond to an inverse multiplexing end-point, a method including a step wherein said at least one connection end-point is informed of a bandwidth change by at least one inverse multiplexing end-point aware of said bandwidth change.

These and other objects are achieved, in another aspect of the present invention, by a method for improved handling of link failure in a transport network using inverse multiplexing, a method including a step wherein said transport network takes preventive and/or defence actions against congestion due to said link failure, based on a criterion of traffic priority, in a way as to protect traffic of high priority against said congestion.

Other aspects or objects of the present invention are defined in the appended claims.

### BRIEF DESCRIPTION OF THE DRAWINGS

These and other objects of the present invention will become more apparent from the following description taken in conjunction with the accompanying drawings, wherein:

FIG. 1 is intended to recall the general architecture of a mobile communication system, such as in particular UMTS,

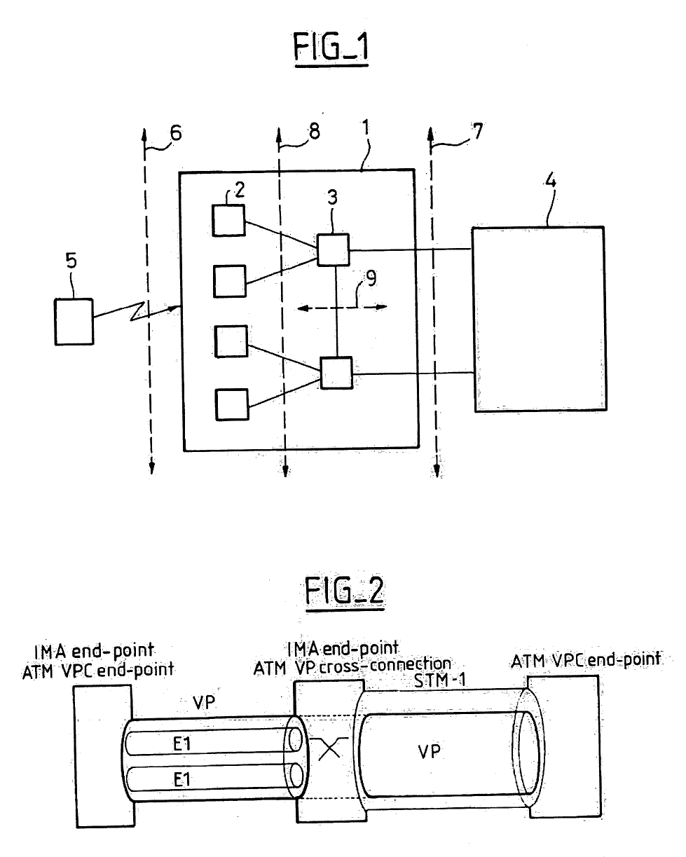

FIGS. 2, 3, 4 are intended to illustrate examples of application of the present invention,

FIGS. 5, 6, 7, 8 are intended to illustrate different examples of embodiment of the present invention.

### MORE DETAILED DESCRIPTION

The present invention may also be explained in the following way.

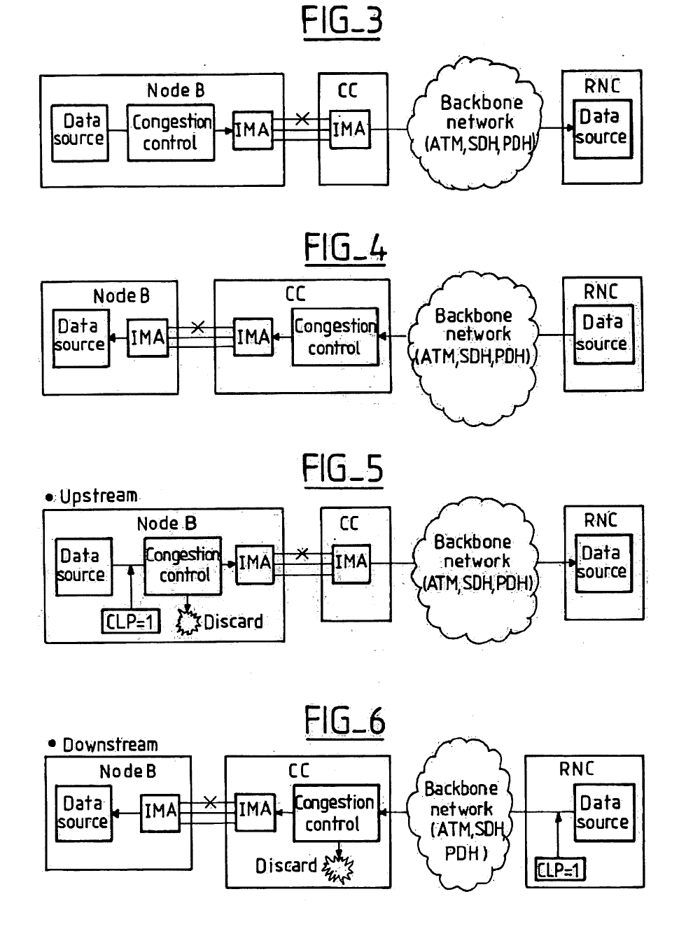

First, in relation with FIG. 3 or 4, the effect of an IMA link failure is envisaged. By way of example, FIGS. 3 and 4 correspond to the example presented in relation with FIG. 2, i.e. to the case of the lub interface defined in UMTS, connecting a Node B (assumed here to support IMA), and a Radio Network Controller (RNC) (assumed here not to support IMA), with the use of an intermediate ATM VP cross-connect (noted CC), terminating the IMA. FIG. 3 illustrates the case of the uplink direction, and FIG. 4 illustrates the case of the downlink direction. Besides, in FIGS. 3 and 4, IMA terminating means (noted IMA) and congestion control means (noted Congestion Control) have been illustrated in the IMA end-points, i.e. Node B and CC, and a data source has been illustrated in the ATM connection end-points, i.e. Node B and RNC.

Let us consider as an example a VCC defined with a bandwidth of 5 Mbit/s, going over an IMA group of three E1 links. If one of the three E1 links fails either in a termination point or in an intermediate cross-connect, the available bandwidth suddenly drops to about 4 Mbit/s. If the bandwidth of the VCC is used at its maximum at the moment of the failure, the buffers of the equipment at the point of failure will rapidly overflow. This will result in rapid cell loss (in that equipment), and cell delay for the cells which will not be discarded. Because of real time constraints in UMTS on the lub interface, cell delay will likely result in cell discard in the Node B (for downlink direction), so that it is quite possible that a large part of the VCC is lost, until the source reacts.

It is recalled that such real time constraints are due to macro-diversity possibility and need for a UE (User Equipment) to receive data on the different radio links by which it is simultaneously connected to different Node B at the same time. Therefore, the RNC needs to provide accurate transmission timing information to the Node B, and if the data arrives too late compared to the time the Node B needs to send that data, according to this transmission timing information, the Node B discards the data. Another reason why a large part of the VCC may be lost is due to AAL 2 multiplexing possibility. It is recalled that AAL2 is a specific ATM Adaptation Layer (AAL) which allows several low bit rate connections to share a same ATM connection, by multiplexing several short packets called CPS packets into a same ATM cell. It is possible (and it is often the case in high load situation) that AAL 2 CPS packets are spread over several ATM cells. If this is the case, the loss of one ATM cell results in the loss, not only of the data contained in this ATM cell, but also of the data contained in all the CPS packets spread over several ATM cells including this ATM cell. In addition, for data services in particular, the payload of a CPS packet is only a part of an AAL2 SSSAR SDU (Service Specific Segmentation And Reassembly Service Data Unit, AAL2 SSSAR being specified in ITU-T 1.366.1, which may include up to several thousands of bytes. The loss of a single CPS packet will imply the loss of the complete SDU.

There may be different ways by which an IMA end-point becomes aware of a link failure, such as, as indicated above:
in the case of link failure occuring in the transmission direction from an IMA end-point, by detection of buffer overflow,
in the case of link failure occuring in the transmission direction to an IMA end-point, by detection of reception delay.

As understood by the skilled person, other ways could of course be possible, such as for example, in the case of link failure occuring in the transmission direction from an IMA end-point, by supervision of the transmission link status information carried over that link, such as AIS, RDI or LOS, as defined for the case of E1 link in ITU-T recommendation G.775, or other faults as defined in ITU-T recommendation G.732 (failure of power supply, failure of codec, loss of incoming signal, loss of frame alignment, excessive bit error ratio, alarm indication received), or corresponding faults for other transmission means on which IMA can be applied.

There are two areas where action may be required in case of IMA link failure: one is for prevention; the other is for immediate (or very short term) defence.

1. Preventive Actions

As a preventive measure, the high priority traffic and lower priority traffic should be distinguished (possibly with several levels). This has no effect as long as no congestion is experienced. Only in case of congestion, the lower priority traffic may be impacted, depending on the level of congestion.

The indication of the priority in case of congestion can be performed at application layer, and exchanged between end points when the corresponding connections are established.

In addition, at transport level, the highest priority traffic can be protected by the use of the CLP (Cell Loss Priority) bit set to 0 by the ATM connection termination point.

In the case of ML-PPP, different service classes can be used instead. ML-MC PPP offers four classes. In the following chapters ATM-CLP can be read as service class in the ML/MC-PPP case.

1.1. Marking High Priority Traffic at Transport Level (Use of CLP Bit)

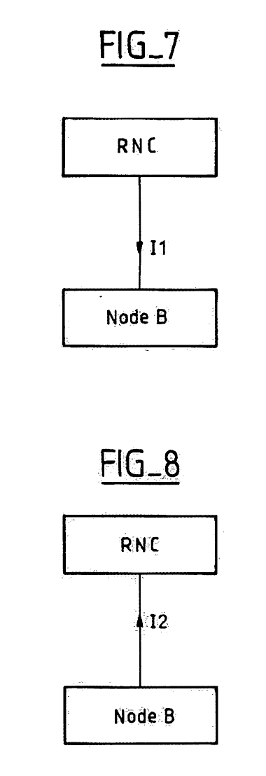

One possible starting point to solve the problem is to rely on the Cell Loss Priority (CLP) bit mechanism defined in ATM (see ITU-T recommendation 1.371: Traffic control and congestion control in B-ISDN), as illustrated by way of example in FIG. 5 (for the uplink) or in FIG. 6 (for the downlink) for the same example than the one illustrated in FIGS. 3, 4. At any time, each ATM cell is marked with a priority indicator (CLP bit). This has no effect, except in case of congestion encountered in the network. If the network encounters congestion, it will discard CLP 1 cells first, as illustrated by way of example in FIG. 5 or 6. On the contrary, the cells with CLP 0 will not be discarded. Note that in absence of congestion, there is no difference in handling cells (in particular CLP bit has nothing to do with time priority: ATM layer guarantees in-sequence delivery, and a CLP 0 cell will never overtake a CLP 1 cell). Marking of high priority traffic at transport level thus consists in appropriately choosing the CLP at source level, depending on the importance the cell has with respect to a potential congestion problem.

Advantageously, at least the cells of the control plane should be marked with CLP 0. It is also possible to mark important cells of the user plane with CLP 0, but care should be taken that if too many cells are marked, the efficiency of the mechanism may be lost. For instance, if an IMA bundle is made of two links, no more than half the cells should be marked with CLP 0. If the bundle is made of four links, and if the protection needs to be efficient even if the case of loss of three out of the four links, then no more than 25% of the cells should be marked with CLP 0.

Marking only the control plane cells is an easy choice, and the proportion of the control plane cells over the total traffic is in general sufficiently low.

Distinguishing important cells with CLP bit can be a way to guarantee that even in case of link failure inside an IMA group, the bandwidth of the bundle made of the remaining links is still sufficient to enable important cells to go through. This of course assumes that the congestion mechanisms implemented in the crossed ATM nodes follow ITU-T recommendation 1.371.

Note that the distinction between high priority traffic and low priority traffic is performed at the time the traffic is established, i.e. independently of any congestion situation. The CLP marking has to be performed on both directions, by each source (Node B and RNC in the case of lub interface). This implies that both the Node B and the RNC know what cells should be marked with CLP=0.

If only the control traffic is to be marked, this is simple for both ends to know it, by configuration.

If also some of the user plane traffic is to be marked with CLP=0, then the RNC has to inform the Node B of the importance of the user plane traffic with regard to potential congestion, as illustrated by way of example in FIG. 7 with information noted 11 sent from RNC to Node B.

There is already a parameter in NBAP (Node B Application Part) protocol that could be used for that purpose. This parameter is called “Allocation/Retention Priority” and indicates the priority level in the allocation and retention of Node B internal resources. The Node B could extend the use of this parameter to select which user plane traffic needs to be protected against congestion. It is recalled that NBAP is a signalling protocol used on the lub interface of UTRAN, at a radio network layer, i.e. for the handling of radio network related issues (see 3GPP TS 25.433: UTRAN lub interface NBAP signalling). Use of a specific new parameter defined in NBAP could also be considered. Use of ALCAP protocol information could also be considered. It is recalled that ALCAP (<< Access Link Control Application Part >>) is a signalling protocol used in UTRAN, at a transport network layer, i.e. for the handling of transport technology related issues (including the establishing of AAL2 connections); see:
3GPP TS 25.426: UTRAN lur and lub Interface Data Transport & Transport Signalling for DCH Data Streams,
3GPP TS 25.435: UTAN lub Interface User Plane Protocols for Common Transport Channel Data Streams,
ITU-T recommendation Q.2630-1: AAL type 2 Signalling Protocol (Capability Set 1),
ITU-T recommendation Q.2630-2: AAL type 2 Signalling Protocol (Capability Set 2).

Nothing exists for that purpose in the existing versions of that protocol (ITU-T Q.2630.1 and ITU-T Q.2630.2), so that an extension would have to be defined in these protocols for that purpose.

Note that in case the user plane traffic needs to be protected, it may become a little more complex at ATM level, depending on whether AAL2 connections of different priorities are multiplexed or not on the same VC. If a VC is defined per priority, the marking is straightforward. If AAL2 connections of different priorities are multiplexed on the same VC, any ATM cell containing at least part of a CPS packet of high priority should be protected by CLP 0.

1.2. Marking High Priority Traffic at Application Level (Example of UTRAN Lub Interface)

At radio link establishment time, the RNC may indicate its priority by the information element “Allocation/Retention Priority”. This information element is normally used in case of radio congestion, when a higher priority radio link needs to be established, if this cannot be done without releasing an already existing radio link. Several priority levels are defined in 3GPP TS 25. 433, and the lower priority radio links should be released first.

The same information element can be used to cover the transport congestion problem. In case of congestion detection, the Node B can locally decide to release the connections corresponding to the low priority radio links.

2. Defence Actions

2.1. Discarding of CLP1 Cells by ATM Equipment in Case of Congestion

As a defence action in case of experienced IMA link failure, the CLP bit can be used in case of congestion, as defined in ITU-T recommendation 1.371. In case of congestion, cells marked with CLP 0 will in principle be handled with higher priority than cells with CLP 1 by any ATM equipment.

2.2. Release of Low Priority Connections by the Endpoint Equipment in Case of Congestion

If one endpoint is aware of the IMA link failure, it can decide to release part or all of the low priority traffic, depending on the level of congestion.

2.3. Transfer of Information of the IMA Link Failure (Sending an Application Control Message from Node B to RNC about the IMA Link Failure)

If one endpoint is aware of the IMA link failure, it can inform the other endpoint of the situation, so that the other side can also take actions on its side, for example release calls on its side. In the example of lub interface, the Node B can inform the RNC, as illustrated by way of example in FIG. 8 with information noted 12 sent by the Node B to the RNC. The Node B can inform the RNC by transferring information at a level above ATM to the RNC. More generally the point terminating the IMA bundle and detecting the failure indicates the loss of the link, in a form or another. A convenient form is in particular an indication of the percentage of the total bandwidth of the concerned VP, which remains available (or in an equivalent way, the percentage that becomes unavailable).

Let us assume that IMA operates in “symmetrical configuration and operation”. Once the state of both Tx and Rx of a certain physical link in IMA group becomes “Active”, this link is used as a part of IMA group and ATM cell is passed from/to upper layer.

If the Tx/Rx of (at least) one link gets out of “Active” state (event A) due to the detection of failure, this link is never used for ATM cell transmission/reception, and the cells are transmitted/received using the rest of links still “active” in IMA group. This may lead to the lub overload situation. Therefore, the Node B and the RNC shall take the actions to prevent from lub overload described in this section.

On the other hand, if the state of the link becomes “Active” again (event B) due to the recovery of failure, this link should be used again for ATM cell transmission/reception in the IMA group, and the Node B and the RNC shall take the recovery actions described in this section.

Note: IMA has parameters P_{TX}, P_{RX}, which indicate the minimum number of links required for IMA group. When the number of “Active” links become less than these values, the IMA group stops Tx/Rx of any ATM cells even if one or more physical links is still alive in the group. What is described here is an example, which does not come under this case. That is, it is the case when the number of “Active” links is still more (or equal) than P_{TX} and P_{RX}, after the link is failed.

In case of event A, to recover from overload, it is required to reduce load put on the IMA group and this means that RNC or Node-B has to be aware of link failure on the IMA group (occurrence of event A). According to the failure information, they have to reduce the load to fit the remaining bandwidth or to prevent adding new load on that IMA group. Also, RNC or Node B has to be aware of link recovery (occurrence of event B) to retrieve from the overload situation.

On the Node-B side, it is easy to get link status information from an IMA unit because it is implemented inside Node-B. The information is simply transferred from the IMA unit, to the ATM module.

On the RNC side (assuming the IMA unit is not implemented there, but in an intermediate cross-connect, as illustrated in FIG. 2), it is proposed to implement a proprietary NBAP message to transfer the link status. The use of ALCAP protocol information could be a possible alternative. Nothing exists for that purpose in the existing versions of that protocol (see above-mentioned ITU-T recommendations Q.2630.1 and Q. 2630.2), so that an extension would have to be defined in these protocols for that purpose.

An example of method could for example include the following steps:
1) A failure occurs on a downlink (DL) or uplink (UL) link in an IMA group,
2) The IMA unit in Node B detects the link failure and reports it to the Node B control,
3) The Node B control generates a proprietary NBAP message and sends it to the RNC through UL lub,
4) RNC adjusts load on the link to the level allowed by the remaining capacity. This covers short-term actions (such as releasing low priority calls). It also includes medium term actions such as updating the connection admission control parameters, so that new calls are only accepted up to a point compatible with the failure situation.
5) Conversely, when the link is repaired and put back in traffic, the Node B informs the RNC by a similar mechanism.

Examples of such a proprietary message could be (the following list not being limitative):
A pure proprietary NBAP message completely newly defined.
The Resource Status Indication message which could be used with Information Elements (IEs) with a specific definition.

In any case, the message should contain the information, which may affect the available bandwidth. Following information is proposed to be included in this message.
The number of active E1 links in the IMA group,
The type of link (e.g. E1, T1 . . . ),
IMA frame length.

Other parameters are also possible, e.g. directly providing the available bandwidth.

The message is to be sent to RNC on the change of any element, which affects its available bandwidth.

As a generalisation, it is also proposed that when any elements are changed which may lead to the change of available bandwidth, Node B informs RNC of its information. This will allow RNC to control available bandwidth dynamically without manual operation, e.g. when:
the physical link is added/removed to/from IMA group intentionally (e.g. in case IMA group is operated with 2 E1 at first, and 1 E1 is added when the traffic is increased: it can be done without any manual operation in RNC).
the IMA parameters are changed (which leads to change of bandwidth) etc.

As indicated above in 2.2, in case of congestion, the Node B can locally decide to release low priority connections, based on the priority of the corresponding radio link, as indicated by the RNC at radio link establishment time.

This may be a complementary action to what is described above in 2.3, or an alternative, avoiding the need to modify the standard.

As already indicated, the present invention is not limited to the example presented in relation FIG. 2 or 3 to 6. For example, in the case where IMA would not terminate in the Node B but in an intermediary (not illustrated) node, a solution could be that the Node B is first informed of an IMA link failure by said intermediary node, and the Node B then informs the RNC of said link failure. This solution would of course require that the intermediary Node can inform the Node B of the IMA link failure, such as for example by means of an application defined above ATM layer between that intermediary node and the Node B.

In a more general way, in a transport network using inverse multiplexing such that at least one connection end-point does not correspond to an inverse multiplexing end-point, a method according to the present invention provides at least one step wherein said at least one connection end-point is informed of a bandwidth change by at least one inverse multiplexing end-point aware of said bandwidth change.

The present invention in particular allows the following advantages:
The solution is quick: it only requires the detection time in the Node B, and the transmission time of the information to the RNC, then the defence action inside the RNC.
This solution is reliable: the failure of the link is transferred to RNC obviously. In addition, this is conveyed by ATM cell with its CLP 0, so it is expected to reach RNC in very high probability.
It does not rely on complex ATM Performance Management cells.
It does not imply the presence of the O&M system to react.

1. A method for improved handling of dynamic bandwidth changes in a transport network using inverse multiplexing such that at least one connection end-point does not correspond to an inverse multiplexing end-point, a method including a step wherein said at least one connection end-point is informed of a bandwidth change by at least one inverse multiplexing end-point aware of said bandwidth change.

2-6. (canceled)

7. A method according to claim 1, wherein a bandwidth change corresponds to a failure of at least one link in a group of links between two inverse multiplexing end-points.

8-10. (canceled)

11. A method according to claim 1, including a step wherein said at least one connection end-point uses information indicative of a bandwidth change, received from said at least one inverse multiplexing end-point, to correspondingly adjust the traffic load.

12. A method according to claim 7, including a step wherein said at least one connection end-point uses said information indicative of a bandwidth change, received from said at least one inverse multiplexing end-point to take defence actions against congestion due to said link failure.

13. A method according to claim 1, wherein said transport network corresponds to the radio access network of a mobile communication system, and a first and a second connection end-point respectively correspond to a first and a second network element communicating across a given interface of said radio access network.

14. A method according to claim 13, wherein said step wherein said at least one connection end-point is informed of a bandwidth change by at least one inverse multiplexing end-point aware of said bandwidth change includes a step wherein information indicative of a bandwidth change is sent from said first network element to said second network element via a signalling protocol used on said given interface.

15-16. (canceled)

17. A method according to claim 13, wherein said first and second network elements respectively correspond to a base station and to a base station controller.

18. A method according to claim 17, including a step wherein said base station controller uses information indicative of a bandwidth change received from said base station to adjust the traffic load in a corresponding way.

19-23. (canceled)

24. A network element for the radio access network of a mobile communication system, including means for performing a method according to claim 1.

25. A base station, for the radio access network of a mobile communication system, including means for performing a method according to claim 1.

26. A base station controller, for the radio access network of a mobile communication system, including means for performing a method according to claim 1.

27. A method for improved handling of link failure in a transport network using inverse multiplexing technique, a method including a step wherein said transport network takes preventive and/or defence actions against congestion due to said link failure, based on a criterion of traffic priority, in a way as to protect traffic of high priority against said congestion.

28-35. (canceled)

36. A method according to claim 27, wherein high priority traffic to be protected against said congestion is determined having regard to the least admissible traffic corresponding to the highest number of links failure in an inverse multiplexing for ATM group.

37-39. (canceled)

40. A method according to claim 27, wherein said transport network corresponds to the radio access network of a mobile communication system, enabling two network elements to communicate across a given interface of said radio access network.

41. A method according to claim 40, including a step wherein a first network element receives from a second network element information representative of traffic priority to be used as said criterion.

42. A method according to claim 41, wherein said first network element receives said information from said second network element via a signalling protocol used on said given interface.

43-44. (canceled)

45. A method according to claim 41, wherein said first and second network elements respectively correspond to a base station and to a base station controller.

46-48. (canceled)

49. A network element, for the radio access network of a mobile communication system, including means for performing a method according to claim 27.

50. A base station, for the radio access network of a mobile communication system, including means for performing a method according to claim 27.

51. A base station controller, for the radio access network of a mobile communication system, including means for performing a method according to claim 27.
